(19) United States
(12) Patent Application Publication
(10) Pub. No.: US 2012/0049735 A1
(43) Pub. Date: Mar. 1, 2012

(54) Lighting device

(75) Inventors: Chih-Hsien Wu, San Chung City (TW); Sen-Yuh Tsai, San Chung City (TW)

(73) Assignee: Unity Opto Technology Co., Ltd., San Chung City (TW)

(21) Appl. No.: 12/923,415

(22) Filed: Sep. 21, 2010

(30) Foreign Application Priority Data
Aug. 25, 2010 (TW) 099216375

(51) Int. Cl. H01J 13/46

(52) U.S. Cl. 315/35

(57) ABSTRACT

A lighting device includes a base, a hollow body, a substrate board, and a cover. The base includes a control unit mounted thereto. The hollow body includes an inside wall and has an end coupled to the base. The substrate board has a surface to which at least one light emission element is mounted and has a circumference engaging and supported by the inside wall of the hollow body to ensure secure and fixed positioning. The cover is set on and covers an opposite end of the hollow body. Further, the substrate board can be of various shape or configuration to increase illumination angle of the light emitted from the light emission element and to expand heat dissipation area.

### FIELD OF THE INVENTION

The present invention relates to a lighting device, and in particular to a lighting device for illuminating a surrounding environment.

### BACKGROUND OF THE INVENTION

Products associated with light-emitting diode (LED) are prevailing nowadays. Almost all industries use LEDs. Yet, the application and development of LEDs, especially for illumination purposes, is still on progress. Conventionally, an LED based lighting device comprises a single LED. Although the LED is advantageous in low power consumption, high luminosity, long lifespan, small volume, and high power, yet the illumination angle for light emitting from such a light source is small and significant heat dissipation is needed for such a lighting device. These problems are difficult to solve.

Thus, it is desired to have a lighting device that facilitates increase of illumination angle of LED and helps dissipation of heat.

### SUMMARY OF THE INVENTION

An objective of the present invention is to provide a lighting device, which comprises a substrate board having a primary portion a circumference to which a plurality of extension portions is connected in an angled manner with light emission elements being mounted to the extension portions to thereby increase the illumination angle of the light emission elements and expand the heat dissipation area.

Another objective of the present invention is to provide a lighting device, which comprises a hollow body having an inside wall that engages and thus fixedly supports a circumference of a substrate board so as to ensure secure and fixed positioning.

To realize the above objectives, the present invention provides a lighting device, which comprises a base, a hollow body, a substrate board, and a cover. The base comprises a control unit mounted thereto. The hollow body comprises an inside wall and has an end coupled to the base. The substrate board has a surface to which at least one light emission element is mounted and has a circumference engaging and fixedly supported by the inside wall of the hollow body. The cover is set on and thus covers an opposite end of the hollow body.

### BRIEF DESCRIPTION OF THE DRAWINGS

The present invention will be apparent to those skilled in the art by reading the following description of preferred embodiments thereof with reference to the drawings, in which:

FIG. 1 is an exploded view of a lighting device constructed in accordance with a first embodiment of the present invention;

FIG. 2 is a cross-sectional view of the lighting device according to the first embodiment of the present invention;

FIG. 3 is an exploded view of a lighting device constructed in accordance with a second embodiment of the present invention; and

FIG. 4 is a cross-sectional view of the lighting device according to the second embodiment of the present invention.

### DETAILED DESCRIPTION OF THE PREFERRED EMBODIMENTS

### First Embodiment

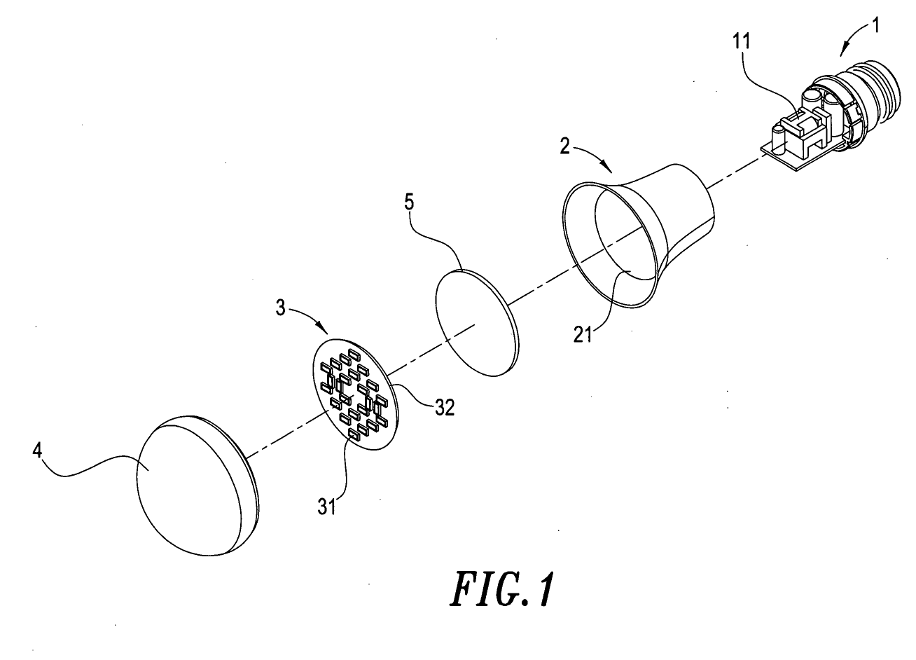

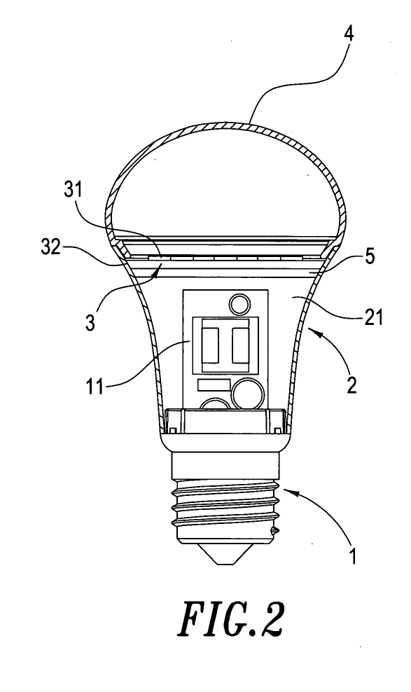

With reference to the drawings and in particular to FIGS. 1 and 2, which respectively show an exploded view and a cross-sectional view of a lighting device constructed in accordance with the present invention, the lighting device of the present invention comprises a base 1, a hollow body or barrel 2, and a substrate board 3.

The base 1 comprises a control unit 11 mounted thereto. The hollow body 2 comprises an inside wall 21 and has an end coupled to the base 1. At least one light emission element 31 is mounted to a surface of the substrate board 3. The substrate board 3 has a circumference that is set in engagement with and thus fixed to the inside wall 12 of the hollow body 2.

Further, in practice of the invention, a cover 4 can be additionally provided. The cover 4 is set on and thus covers an opposite end of the hollow body 2.

Preferably, the light emission element 31 comprises a light-emitting diode (LED) and the substrate board 3 has an opposite surface to which at least one heat dissipation layer 5 is attached.

### Second Embodiment

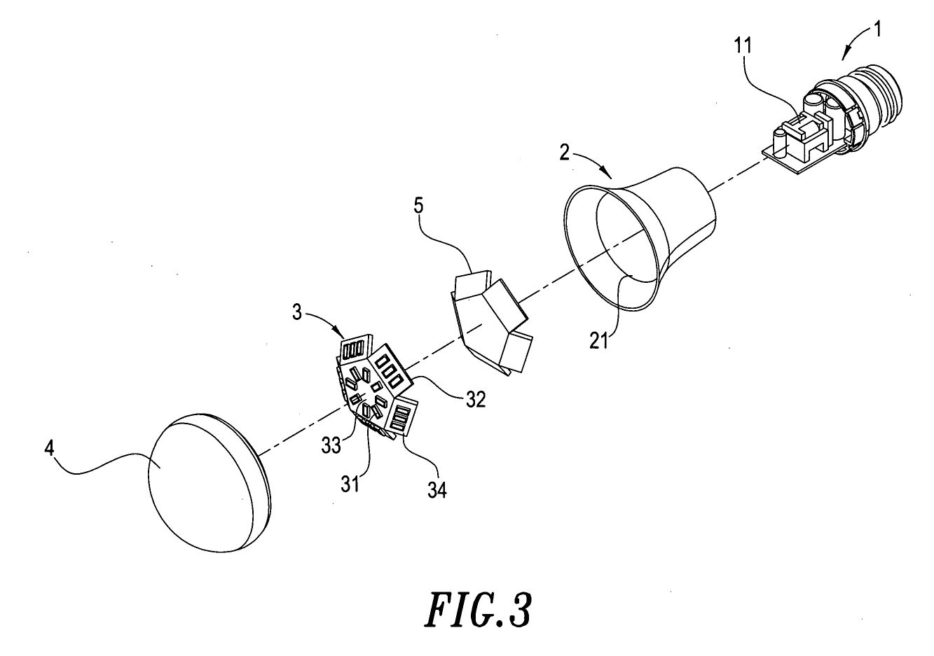

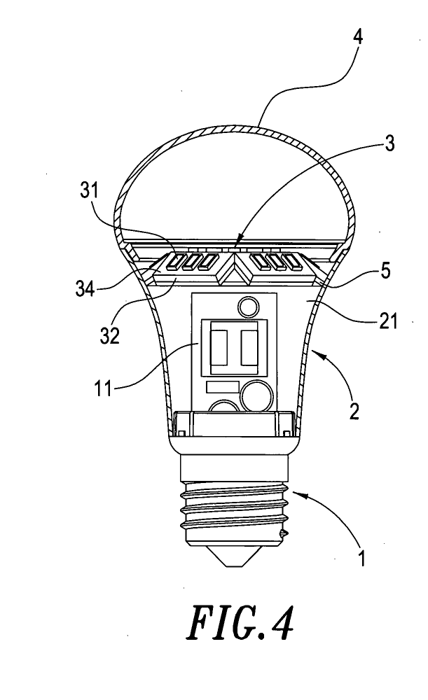

Referring to FIGS. 3 and 4, a lighting device constructed in accordance with a second embodiment is shown. The second embodiment of lighting device is of substantially the same construction as that of the first embodiment and thus no detailed description will be given except for the substrate board 3 of the second embodiment, which is of a different form from that of the first embodiment. As shown in these drawings, the substrate board 3 comprises a primary portion 33 and a plurality of extension portions 34 that is coupled to a circumference of the primary portion 33.

The primary portion 33 is preferably of a polygonal shape having a plurality of edges collectively defining the circumference of the primary portion 33. Each of the edges comprises one of the extension portions 34 extending therefrom. Each extension portion 34 forms an inclined angle with respect to a plane of the primary portion 33. Each extension portion 34 carries at least one light emission element 31 mounted thereon. Each extension portion 34 has an edge, which is opposite to the primary portion 34, engaging and supported by the inside wall 21 of the hollow body 2. The substrate board 3 has a surface to which at least one heat dissipation layer 5 is attached.

In summary, the present invention provides the following advantages:

With the circumference of the primary portion 33 of the substrate board 3 connected to the extension portions 34 in an angled manner and with the light emission elements 31 mounted to the extension portions 34, illumination angle of light from the light emission elements 31 is increased and the area of heat dissipation is also expanded. With the inside wall 21 of the hollow body 2 engaging and thus supporting the circumference 32 of the substrate 3, securely and fixedly positioning can be realized.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A lighting device, comprising:
a base, which comprises a control unit mounted thereto;
a hollow body, which comprises an inside wall and has an end coupled to the base; and
a substrate board, which has a surface to which at least one light emission element is mounted and has a circumference engaging and supported by the inside wall of the hollow body.

2. The lighting device as claimed in claim 1, wherein the substrate board comprises a primary portion and a plurality of extension portions that is coupled to a circumference of the primary portion.

3. The lighting device as claimed in claim 2, wherein the primary portion is of a polygonal shape having a plurality of edges from which the extension portions respectively extend outward, each of the extension portions forming an inclined angle with respect to the primary portion and having a remote edge engaging and supported by the inside wall of the hollow body.

4. The lighting device as claimed in claim 2, wherein each of the extension portions comprises a light emission element mounted thereon.

5. The lighting device as claimed in claim 1 or 3, wherein the substrate board has an opposite surface to which at least one heat dissipation layer is attached.

6. The lighting device as claimed in claim 1 or 4, wherein the light emission element comprises a light-emitting diode.

7. The lighting device as claimed in claim 1 further comprising a cover that is set on and covers an opposite end of the hollow body.
